(19) United States
(12) Patent Application Publication
(10) Pub. No.: US 2003/0033690 A1
(43) Pub. Date: Feb. 20, 2003

(54) Lever handle for a lock

(75) Inventor: Ming-Yu Lin, Kaohsiung Hsien (TW)

Correspondence Address: Bacon & Thomas, 625 Slaters Lane - 4th Floor, Alexandria, VA, 22314, US

(73) Assignee: Taiwan Fu Hsing Industrial Co., Ltd., Kaohsiung Hsien (TW)

(21) Appl. No.: 09/836,249

(22) Filed: Apr. 18, 2001

(30) Foreign Application Priority Data
Sep. 1, 2000 (TW) 89215294

(51) Int. Cl. B62B 1/00

(52) U.S. Cl. 16/412

(57) ABSTRACT

A lever handle includes a main body and a lid that is engaged with the main body. The main body includes a handle portion and a tubular portion extending from an end of the tubular portion. The handle portion includes an annular wall projecting outward from a side thereof to thereby form a half casing for engaging with the lid. The tubular portion receives a pivot seat or is pivotally engaged with a spindle of a lock.

### BACKGROUND OF THE INVENTION

1. Field of the Invention

The present invention relates to an improved lever handle for a lock that can be manufactured easily in a better production rate for qualified products and that can be used with many kinds of products.

2. Description of the Related Art

Typical lever handles for locks are made of zinc alloy and manufactured by casting. FIG. 1 of the drawings illustrates a conventional lever handle comprising two half members 91 and 92 that together sandwich a main body 93 at one end. They are securely engaged together by soldering. During manufacture of such a conventional lever handle, the end of each half member 91, 92 for sandwiching the main body 93 includes two corner end portions 94 which might deform as a result of collision or impact and thus impede insertion of the main body 93. In addition, the main body 93 tends to deform and becomes skew after it is soldered to the half members 91 and 92, thereby resulting a poor production rate for qualified products. Furthermore, in use, the handle tends to break in the soldering point that is subjected to forces during operation. The conventional handle is thus not durable.

### SUMMARY OF THE INVENTION

It is the primary object of the present invention to provide an improved lever handle that can be manufactured easily in a better production rate for qualified products and that is durable than conventional lever handles.

A lever handle in accordance with the present invention includes a main body and a lid that is engaged with the main body. The main body includes a handle portion and a tubular portion extending from an end of the tubular portion. The handle portion includes an annular wall projecting outward from a side thereof to thereby form a half casing for engaging with the lid. The tubular portion receives a pivot seat or is pivotally engaged with a spindle of a lock.

Other objects, specific advantages, and novel features of the invention will become more apparent from the following detailed description and preferable embodiments when taken in conjunction with the accompanying drawings.

### BRIEF DESCRIPTION OF THE DRAWINGS

FIG. 1 is an exploded perspective view of a conventional lever handle.

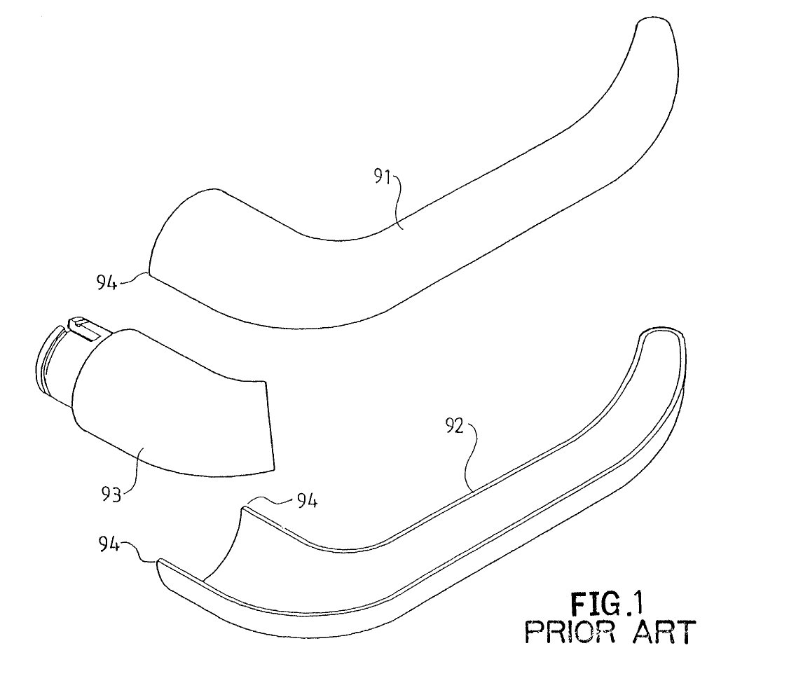

FIG. 2 is an exploded perspective view of a first embodiment of a lever handle in accordance with the present invention.

FIG. 3 is a sectional view of the lever handle in FIG. 2.

FIG. 4 is an exploded perspective view of a second embodiment of the lever handle in accordance with the present invention.

### DETAILED DESCRIPTION OF THE PREFERRED EMBODIMENTS

Preferred embodiments in accordance with the present invention will now be described with reference to the accompanying drawings.

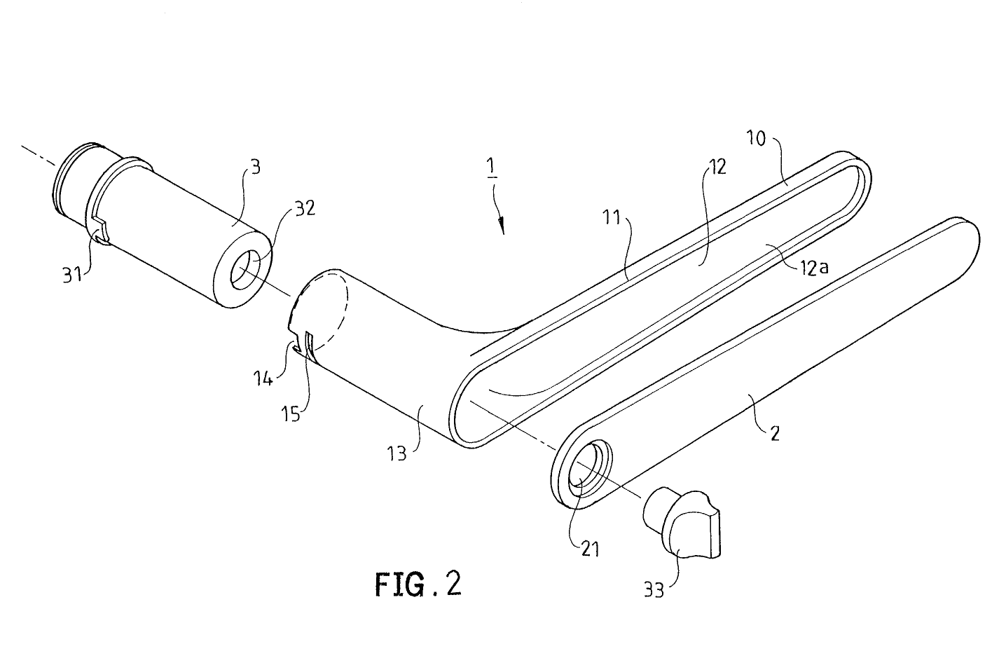

Referring to FIG. 2, a first embodiment of a lever handle in accordance with the present invention generally includes a main body 1, a lid 2, and a pivot seat 3.

The main body 1 is made of metal and preferably made by means of pressing or rolling to reduce the amount of the material and the weight of the resultant product. The main body 1 comprises a handle portion 10 and a tubular portion 13 extending from an end of the handle portion 10. The handle portion 10 includes an annular wall 11 projecting outward from a side 12 thereof, thereby defining a half casing with a compartment 12a for receiving the lid 2. The tubular portion 13 receives the pivot seat 3. In this embodiment, the tubular portion 13 includes an engaging notch 14 and the pivot seat 3 includes a protrusion 31 for engaging with the engaging notch 14. The main body 1 further includes an engaging slot 15 such that the main body 1 can also be engaged with a spindle.

The lid 2 is a plate or half casing made of metal. The lid 2 can be engaged with the main body 1 to form a handle. The lid 2 and the main body 1 can be soldered together to provide a firm engagement. The lid 2 includes a hole 21 that is aligned with a portion of the main body 1 from which the tubular portion 13 extends. A turn-button 33 is extended through the hole 21 to allow locking and unlocking operations.

When the lever handle in accordance with the present invention is used with a lock that can be operated without a key (e.g., a lock for a passage door), the pivot seat 3 is pivotally mounted in the tubular portion 13, which, in turn, is connected via a spindle (not shown) to an actuating wheel (not shown) of a latching mechanism (not shown) for controlling retraction of a latch bolt (not shown). As mentioned above, the pivot seat 3 includes a protrusion 31 for engaging with the engaging notch 14 of the main body 1. The pivot seat 3 further includes a hole 32 for rotatably receiving the turn-button 33.

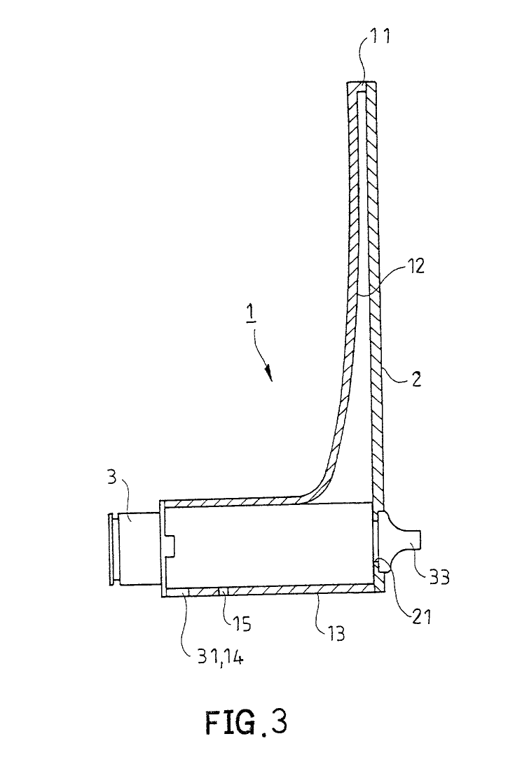

Referring to FIG. 3, after the main body 1 and the lid 2 are fixed together by soldering or the like, the pivot seat 3 is mounted into the pivot seat 13 of the main body 1 to form a lever handle for a passage door of the type that can be locked without a key.

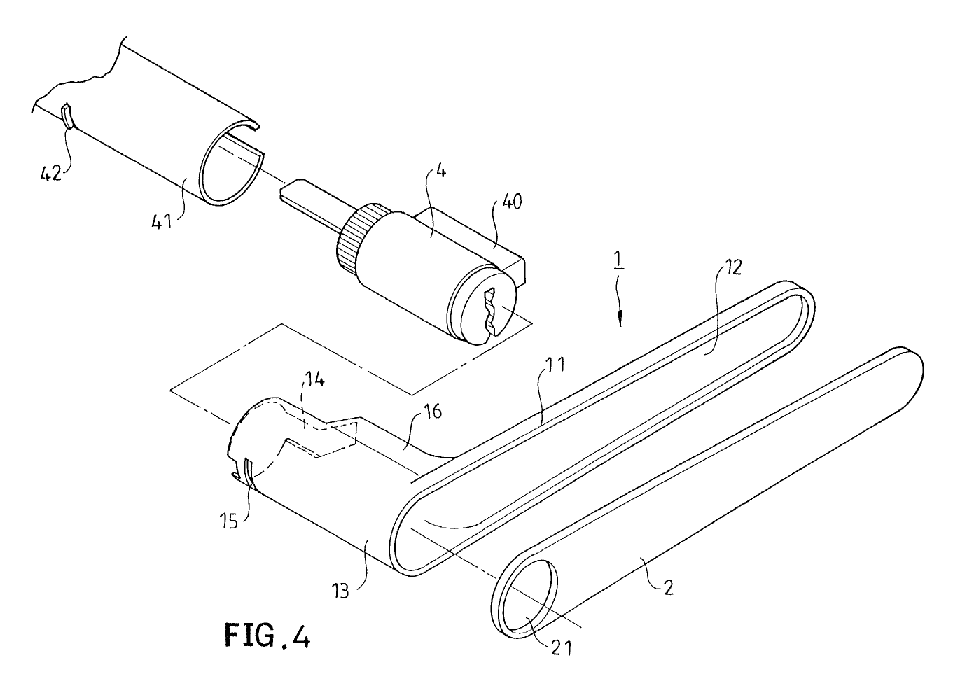

FIG. 4 illustrates a second embodiment of the lever handle in accordance with the present invention. The lever handle of this embodiment can be used with a lock 4 that is mounted in a spindle 41. A protrusion 42 on the spindle 41 is engaged with the engaging slot 15 of the main body 1. In addition, the main body 1 includes a positioning compartment 16 for receiving a positioning block 40 of the lock 4. Thus, the lever handle in accordance with the present invention can also be used with key-operating locks.

According to the above description, it is appreciated that the weight of the lever handle is reduced to thereby reduce the cost. In addition, manufacture of the lever handle is easier and simpler. Furthermore, the lever handle in accordance with the present invention can be used with either passage doors that can be operated without using keys or key-operating doors. Thus, the application of the lever handle in accordance with the present invention is wider. Further, the lever handle in accordance with the present invention has a better production rate with qualified products and is more durable.

Although the invention has been explained in relation to its preferred embodiment as mentioned above, it is to be understood that many other possible modifications and variations can be made without departing from the scope of the invention. It is, therefore, contemplated that the appended claims will cover such modifications and variations that fall within the true scope of the invention.

What is claimed is:

1. A lever handle comprising:
a main body including a handle portion and a tubular portion extending from an end of the tubular portion, the handle portion including an annular wall projecting outward from a side thereof to thereby form a half casing; and
a lid engaged with the half casing of the main body.

2. The lever handle as claimed in claim 1, wherein the main body and the lid are soldered together.

3. The lever handle as claimed in claim 1, wherein the tubular portion includes an engaging notch adapted to be engaged with a protrusion of a pivot seat.

4. The lever handle as claimed in claim 3, wherein the lid includes a hole that is aligned with the tubular portion of the main body.

5. The lever handle as claimed in claim 1, wherein the tubular seat includes an engaging slot adapted to be engaged with a protrusion of a spindle of a lock.

6. The lever handle as claimed in claim 5, wherein the main body includes a positioning compartment adapted to receive a positioning block of the lock.

7. The lever handle as claimed in claim 1, wherein the main body and the lid are formed by pressing or rolling.
